(19) United States
(12) Patent Application Publication
(10) Pub. No.: US 2016/0307260 A1
(43) Pub. Date: Oct. 20, 2016

(54) INFORMATION PROCESSING SYSTEM AND METHOD THEREFOR

(71) Applicant: LINE BIZPLUS PTE, LTD., International Plaza (SG)

(72) Inventors: Eun Su PARK, Seongnam-si (KR); Young Su KO, Seongnam-si (KR); Kye Wan JUN, Seongnam-si (KR); Kyun PARK, Seongnam-si (KR); Hee Young KIM, Seongnam-si (KR); Jin Woo LEE, Seongnam-si (KR)

(21) Appl. No.: 14/841,039

(22) Filed: Aug. 31, 2015

(30) Foreign Application Priority Data
Apr. 20, 2015 (KR) 10-2015-0055547

(51) Int. Cl. G06Q 30/06; G06Q 20/32; G06Q 10/08

(52) U.S. Cl. CPC G06Q 30/0635; G06Q 10/083; G06Q 20/322

(57) ABSTRACT

A processing system and a method therefor are provided. The method includes receiving a selection signal that a payment on delivery linked with a mobile application is designated as a payment mode for goods, from a terminal of a user, in which the mobile application is installed, generating an order request signal as a payment server which connects with the terminal over a network matches goods identification data associated with the goods with user identification data of the user who is registered in the mobile application to correspond to each other; verifying ordered records associated with the user identification data and starting a payment session for payment as the terminal executes the mobile application according to an operation of the user who receives the goods, and receiving a payment completion signal generated from the payment session and paying for the goods according to the goods identification data.

### CROSS-REFERENCE TO RELATED APPLICATIONS

The present application claims priority under 35 U.S.C. §119 is made to Korean Patent Application No. 10-2015-0055547 filed Apr. 20, 2015, in the Korean Intellectual Property Office, the entire contents of which are hereby incorporated by reference.

### BACKGROUND

Example embodiments of the inventive concepts described herein relate to processing technologies. For example, at least some example embodiments relate to a method and system for processing information using an application.

As the distribution of the Internet has been expanded, electronic commerce such as Internet shopping is increasing in popularity. Internet shopping may reduce the amount of time that a user spends visiting stores and purchasing goods. Internet shopping may allow the user to compare goods at a glance and purchase goods. When Internet shopping, often times the user may pay for goods using their credit cards or their bank accounts through a settlement platform to purchase goods online.

However, there is a risk that confidential information such as personal credit card information will be exposed in a payment process performed online such as Internet shopping. Further, when Internet shopping, the user may not be able to verify the goods conform to the desires of the user in-person prior to purchasing the goods, therefore, there is a risk the received goods may be different from the desired goods. Therefore, dissatisfaction with goods is increased.

Therefore, there may be a need for technologies for increasing the reliability of online purchases of goods by verifying the goods and paying for the goods.

Korean Patent Laid-Open Publication No. 2011-0081432 discloses a delivery service provider terminal and an electronic commerce method therefor, the entire contents of which are hereby incorporated by reference.

### SUMMARY

Example embodiments of the inventive concepts relate to a system for processing information which allows a user to receive goods and pay for the goods through a mobile application and a method therefor.

At least some example embodiments relate to a processing method implemented with a computer.

In some example embodiments, the method includes receiving, from a user terminal having a mobile application installed therein, a selection signal, the selection signal indicating a payment on delivery as a form of payment for goods purchased by a user associated with the user terminal; generating an order request signal if goods identification data associated with the goods matches user identification data associated with the user; starting a payment session to release payment if the user verifies, via the mobile application, that the user has received the goods; and receiving a payment completion signal generated from the payment session and paying for the goods according to the goods identification data.
In some example embodiments, the receiving a selection signal includes automatically selecting the payment on delivery the form of payment when the user logs in to the mobile application using the user identification data associated with the user.

In some example embodiments, the mobile application is a messenger application or a separate application program linked with the messenger application.

In some example embodiments, the generating an order request signal includes outputting ordered records associated with the goods ordered by the user when the goods identification data is matched to the user identification data.

In some example embodiments, the user identification data comprises a merchant identification (ID) and an order ID, the merchant ID associated with a merchant who sells the goods via a selling site, and the order ID including purchased records of the goods, and the user identification data includes a user ID associated with logging into the mobile application.

In some example embodiments, the generating an order request signal includes providing a notification, the notification indicating that a delivery process of delivering the goods has commenced based on ordered records associated with the goods and delivery information associated with the goods.

In some example embodiments, the generating an order request signal further includes sending a location of the ordered goods to the mobile application when the delivery process commences.

In some example embodiments, starting a payment session includes outputting an ordered record list, the ordered record list including a summary of ordered records corresponding to the goods ordered from the user via the mobile application; and outputting details associated with a selected one of the ordered records when the user selects the selected one of the ordered records on the ordered record list.

In some example embodiments, starting a payment session includes providing an interface for processing that a delivery of the goods and payment corresponding to the selected one of the ordered records are complete when the user indicates that the goods corresponding to the selected one of the ordered records is delivered.

In some example embodiments, starting a payment session includes generating a quick response (QR) code or a bar code, and instructing one or more of a merchant and a delivery service provider to place the QR code or the bar code on the goods; receiving the QR code or bar code from the mobile application after the goods are delivered; and performing the payment by processing a payment transaction corresponding to the ordered records, if the QR code or the bar code is received.

In some example embodiments, starting a payment session includes starting the payment session to process payment for the selected one of the ordered record selected by the user; and performing the payment by processing a payment transaction corresponding to the selected ordered records.

In some example embodiments, starting a payment session includes outputting a message associated with processing the payment transaction through the mobile application as the payment corresponding to the selected one of ordered records is performed.

Some example embodiments relate to a processing system implemented with a computer.

In some example embodiments, the system includes a receiver and a processor. The receiver is configured to receive, from a user terminal having a mobile application installed therein, a selection signal, the selection signal indicating a payment on delivery as a form of payment for goods purchased by a user associated with the user terminal, and receive a payment completion signal generated from a payment session. The processor is configured to generate an order request signal if goods identification data associated with the goods matches user identification data associated with the user, start the payment session to release payment if the user verifies, via the mobile application, that the user has received the goods, and pay for the goods according to the goods identification data.

In some example embodiments, the processor is configured to automatically select the payment on delivery as the form of the payment when the user logs in to the mobile application using the user identification data associated with the user.

In some example embodiments, mobile application is a messenger application or a separate application program linked with the messenger application.

In some example embodiments, the processor is configured to output ordered records associated with the goods ordered by the user when the goods identification data matches the user identification data.

In some example embodiments, the user identification data includes a merchant ID and an order ID, the merchant ID associated with a merchant who sells the goods via a selling site, and the order ID including purchased records of the goods, and wherein the user identification data includes a user ID associated with logging into the mobile application.

In some example embodiments, the processor is configured to transmit a notification, the notification indicating that a delivery processor of delivering the goods has commenced based on ordered records associated with the goods and delivery information associated with the goods.

In some example embodiments, the processor is configured to transmit a location of the ordered goods to the mobile application when the delivery processor commences.

In some example embodiments, the processor is configured to output an ordered record list, the ordered record list including a summary of ordered records corresponding to the goods ordered from the user via the mobile application, and output details associated with a selected one of the ordered records when the user selects the selected one of the ordered records on the ordered record list.

In some example embodiments, the processor is configured to provide an interface for processing that a delivery of the goods and the payment corresponding to the selected one of the ordered records are complete when the user indicates that the goods corresponding to the selected one of the ordered records is delivered.

In some example embodiments, the processor is configured to generate a quick response (QR) code or a bar code, and instructing one or more of a merchant and a delivery service provider to place the QR code or the bar code on the goods, receive the QR code or bar code from the mobile application after the goods are delivered, and perform the payment by processing a payment transaction corresponding to the ordered records, if the QR code or the bar code is received.

In some example embodiments, the processor is configured to start the payment session to processor the payment for the selected one of the ordered records selected by the user, and perform the payment by processing a payment transaction corresponding to the selected ordered records.

In some example embodiments, the processor is configured to output a message associated with processing the payment transaction through the mobile application as the payment corresponding to the selected one of ordered records is performed.

Some example embodiments relate to a processing method.

In some example embodiments, the processing method includes selecting a payment on delivery as a form of payment for goods to be purchased by a user requesting an order for the goods by transmitting, to a payment server, goods identification data associated with the goods and user identification data of the user, providing, when the receipt of the goods to the user is verified, a payment interface to the user, the payment interface allowing the user to authorize payment for the goods, and outputting a message associated with processing a payment transaction corresponding to an ordered record associated with the user identification data in response to the payment for the goods through the payment interface.

In some example embodiments, the requesting includes outputting the ordered record if the goods identification data matches the user identification data.

In some example embodiments, the requesting includes receiving a notification based on the ordered record and delivery information associated with the goods, the notification indicating that a delivery process of the goods has commenced, and receiving a current location of the goods every set time period after the delivery process has commenced.

In some example embodiments, the requesting comprises: outputting an ordered record list, the ordered record list including a summary of the ordered record, and outputting details associated with the ordered record when the ordered record on the output ordered record list is selected.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a drawing illustrating an operation of a payment system according to an example embodiment of the inventive concepts;

FIG. 2 is a block diagram illustrating a configuration of a payment system according to an example embodiment of the inventive concepts;

FIG. 3 is a drawing illustrating a process of ordering goods in a payment system according to an example embodiment of the inventive concepts;

FIGS. 4 to 6 are drawings illustrating a process of performing a payment on delivery in a payment system according to an example embodiment of the inventive concepts;

FIG. 7 is a drawing illustrating a process of outputting ordered records for goods in a payment system according to an example embodiment of the inventive concepts;

FIG. 8 is a drawing illustrating a process of notifying a delivery position for goods in a payment system as a delivery is started according to an example embodiment of the inventive concepts;

FIG. 9 is a drawing illustrating a process of providing notification that a delivery is completed to a delivery service provider in a payment system as a delivery is completed according to an example embodiment of the inventive concepts;

FIG. 10 is a signal sequence diagram illustrating an operation of a payment method in a payment system according to an example embodiment of the inventive concepts; and

FIG. 11 is a block diagram illustrating a configuration of a computer system according to an example embodiment of the inventive concepts.

FIG. 12 is flow chart illustrating an operation of a payment method according to an example embodiment of the inventive concepts.

### DETAILED DESCRIPTION

Example embodiments will be described in detail with reference to the accompanying drawings in which some example embodiments are illustrated. Example embodiments of the inventive concepts, however, may be embodied in various different forms, and should not be construed as being limited only to the illustrated example embodiments. Rather, these example embodiments are provided as examples so that this disclosure will be thorough and complete, and will fully convey the inventive concepts to those skilled in the art. Accordingly, known processes, elements, and techniques are not described with respect to some of the embodiments of the inventive concepts. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concepts.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular example embodiments only and is not intended to be limiting of the example embodiments of the inventive concepts. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which these inventive concepts belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

As appreciated, devices and methods of forming devices according to various example embodiments described herein may be embodied in microelectronic devices such as integrated circuits, wherein a plurality of devices according to various example embodiments described herein are integrated in the same microelectronic device. Accordingly, the cross-sectional view(s) illustrated herein may be replicated in two different directions, which need not be orthogonal, in the microelectronic device. Thus, a plan view of the microelectronic device that embodies devices according to various example embodiments described herein may include a plurality of the devices in an array and/or in a two-dimensional pattern that is based on the functionality of the microelectronic device.

The devices according to various example embodiments described herein may be interspersed among other devices depending on the functionality of the microelectronic device. Moreover, microelectronic devices according to various example embodiments described herein may be replicated in a third direction that may be orthogonal to the two different directions, to provide three-dimensional integrated circuits.

Accordingly, the cross-sectional view(s) illustrated herein provide support for a plurality of devices according to various example embodiments described herein that extend along two different directions in a plan view and/or in three different directions in a perspective view. For example, when a single active region is illustrated in a cross-sectional view of a device/structure, the device/structure may include a plurality of active regions and transistor structures (or memory cell structures, gate structures, etc., as appropriate to the case) thereon, as would be illustrated by a plan view of the device/structure.

Example embodiments disclosed herein may include hardware configured to execute program code including program instructions, software components, software modules, data files, data structures, and/or the like. Examples of program code include both machine code produced by a compiler and higher level program code that is executed using an interpreter. The hardware devices may include one or more processors. The one or more processors are computer processing devices configured to carry out the program code by performing arithmetical, logical, and input/output operations. Once the program code is loaded into the one or more processors, the one or more processors may be programmed to perform the program code, thereby transforming the one or more processors into special purpose processor(s).

Alternatively, or in addition to the processors discussed above, the hardware devices may include one or more Central Processing Units (CPUs), digital signal processors (DSPs), application-specific-integrated-circuits (ASICs), SoCs, field programmable gate arrays (FPGAs), or the like. In at least some cases, the one or more CPUs, SoCs, DSPs, ASICs and FPGAs, may generally be referred to as processing circuits and/or microprocessors. The hardware devices may be configured as special purpose processing circuits and/or hardware devices to perform functions illustrated in one or more of the flow charts or sequence diagrams discussed herein.

The hardware devices may also include one or more storage devices. The one or more storage devices may be tangible or non-transitory computer-readable storage media, such as random access memory (RAM), read only memory (ROM), a permanent mass storage device (such as a disk drive), and/or any other like data storage mechanism capable of storing and recording data. The one or more storage devices may be configured to store program code for one or more operating systems and/or the program code for implementing the example embodiments described herein. The program code may also be loaded from a separate computer readable storage medium into the one or more storage devices and/or the one or more processors using a drive mechanism. Such separate computer readable storage medium may include a USB flash drive, memory stick, Blu-ray/DVD/CD-ROM drive, memory card, and/or other like computer readable storage medium (not shown). The program code may be loaded into the one or more storage devices and/or the one or more processors from a remote data storage device via a network interface, rather than via a computer readable storage medium. Additionally, the program code may be loaded into the one or more storage devices and/or the one or more processors from a remote computing system that is configured to transfer and/or distribute the program code over a network. The remote computing system may transfer and/or distribute the program code via a wired interface, an air interface, and/or any other like tangible or intangible medium. The one or more processors, the one or more storage devices, and/or the program code may be specially designed and constructed for the purposes of the example embodiments, or they may be known devices that are altered and/or modified for the purposes of the example embodiments.

It will be apparent to those skilled in the art that various modifications and variations can be made to the example embodiments without departing from the spirit or scope of the inventive concepts described herein. Thus, it is intended that the example embodiments cover the modifications and variations of the example embodiments provided they come within the scope of the appended claims and their equivalents.

Hereinafter, a description will be given in detail of some example embodiments of the inventive concepts with reference to the accompanying drawings.

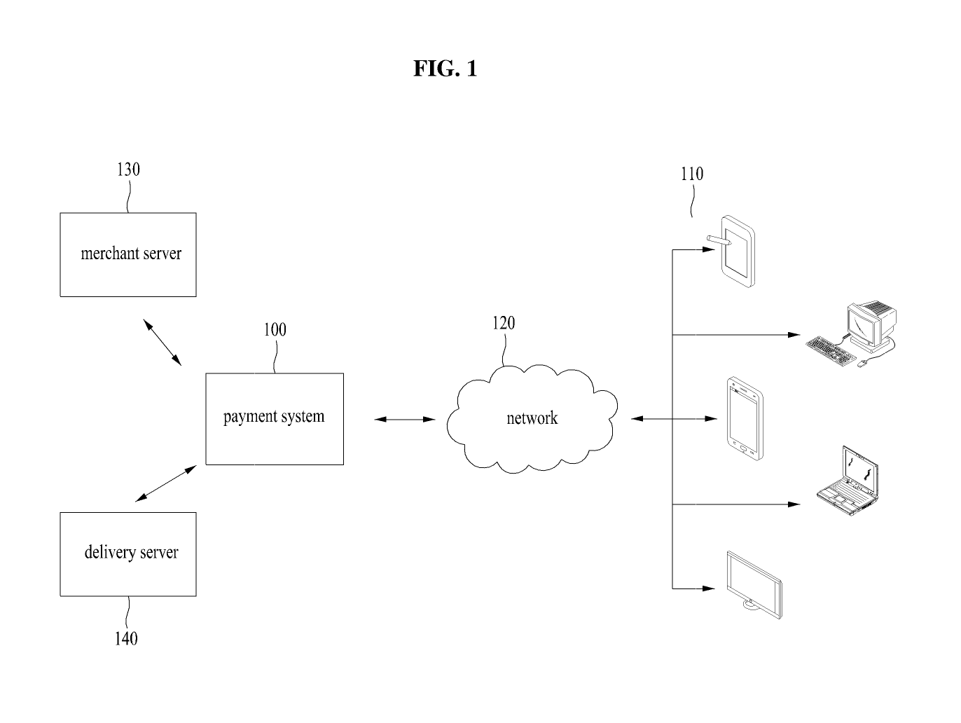

FIG. 1 is a drawing illustrating an operation of a payment system according to an example embodiment of the inventive concepts.

Referring to FIG. 1, a payment system 100 and a user terminal 110 may transmit and receive data through a network 120. The network 120 may include more or less components than the components shown in FIG. 1, connections, and interactions. Also, the payment system 100 may transmit and receive data with a merchant server 130 or/and a delivery server 140.

The merchant sever 130 may be a server driven to sell goods from each seller. For example, the merchant sever 130 may be a server for operating a selling site which sells goods. In this case, a user may purchase goods through the selling site. The merchant server 130 may provide information about goods to the payment system 100 and may request a delivery service provider to deliver goods as the goods are ordered.

The delivery server 140 may be a server driven from each delivery service provider and may notify the payment system 100 of a delivery position as goods purchased by the user are delivered. In this case, the delivery position notified from the delivery server 140 to the payment system 100 may be transmitted to the user terminal 110.

The network 120 may provide communication links between data processing systems, computers, servers, and various devices. The network 120 may indicate worldwide connections between networks, which use a suite of transmission control protocols/Internet protocols (TCPs/IPs), and gateways such that the payment system 100 and the user terminal 110 communicate with each other. In some example embodiments of the inventive concepts, the network 120 may include an intranet, a local area network (LAN), or a wide area network (WAN) or a combination thereof. In some example embodiments of the inventive concept, the network 120 may utilize the Internet to provide at least a portion of the communication links.

The user terminal 110 may be at least one of a personal computer (PC), a notebook, a smartphone, a tablet computer, or a wearable computer. The user terminal 110 may access a web/mobile site associated with the payment system 100 and/or may install and execute a service dedicated application to access the payment system 100. For example, the user terminal 110 may utilize the web/mobile site or the service dedicated application to perform overall service operations, such as a service screen configuration, a data input, data communication, and data storage.

The payment system 100 may be implemented on a payment platform. The payment platform may provide a payment service and/or an environment, which performs payment, to the user terminal 110 which is a client using the payment service.

The payment system 100 may be implemented to be included in a platform of a payment server (not shown) which provides the payment service. However, the scope and spirit of example embodiments of the inventive concepts is not limited thereto. For example, the payment system 100 may be implemented with a system which is independent of the payment server and may be implemented to manage payment through interworking with the payment server.

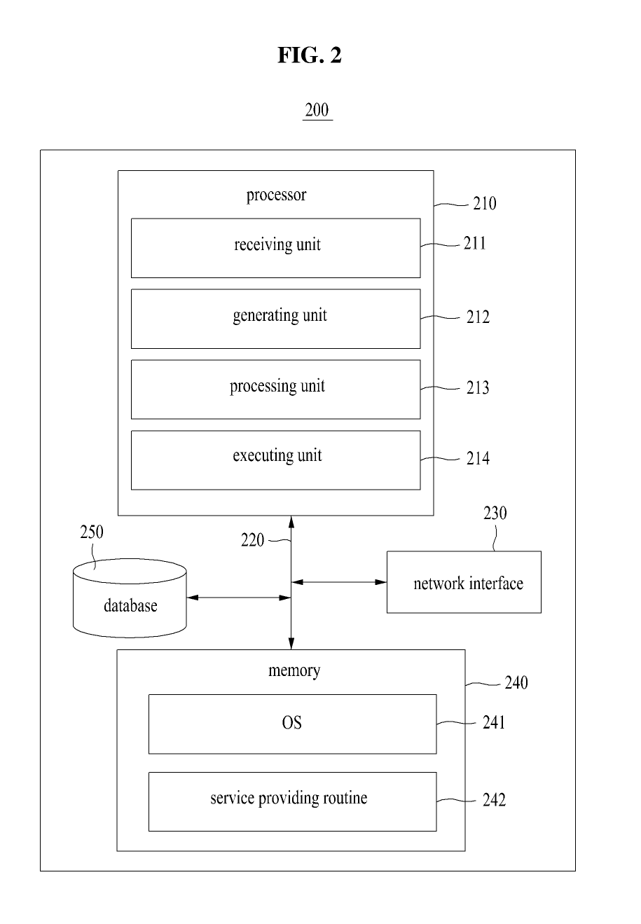

FIG. 2 is a block diagram illustrating a configuration of a payment system according to an example embodiment of the inventive concepts.

A payment system 200 according to an example embodiment of the inventive concepts may include a processor 210, a bus 220, a network interface 230, a memory 240, and a database 250. The memory 240 may include an operating system (OS) 241 and a service providing routine 242.

The processor 210 may include one or more general-purpose or special purpose computers, such as, but not limited to a controller, an arithmetic logic unit (ALU), a digital signal processor, a microcomputer, a field programmable gate array (FPGA), a programmable logic unit, a microprocessor or any other device capable of responding to and executing instructions in a defined manner. The processor 210 may run an operating system (OS) and one or more software applications that run on the OS. The processing device also may access, store, manipulate, process, and create data in response to execution of the software. For the sake of easy understanding, one processing device has been described; however, one skilled in the art will appreciate that the processing device may include multiple processing elements and multiple types of processing elements. For example, the processing device may include multiple processors or a processor and a controller. In addition, other processing configurations are possible, such as parallel processors.

The processor 210 may include a receiving unit 211, a generating unit 212, a processing unit 213, and an executing unit 214. In other example embodiments of the inventive concepts, the payment system 200 may include more elements than that of FIG. 2. For example, the payment system 200 may further include another element such as a display or a transceiver. Further, while the processor 210 is illustrated as being divided into the aforementioned units, these units are provided to increase the clarity of the description of the functions performed by the processor 210 and are not intended as limiting the processor 210. For example, in some example embodiments, the various functions of the units may be performed by other ones of the units. Further, in some example embodiments, the processor 210 may perform the functions of the various units without sub-dividing the functions of the processor 210 into various modules or units.

The memory 240 may be a computer-readable medium and may include permanent mass storage devices such as a random access memory (RAM), a read only memory (ROM), and a disc drive. Also, the memory 240 may store program codes for the operating system (OS) 241 and the service providing routine 242. The program code may be generated from software elements loaded from a computer-readable medium which is independent of the memory 240 using a drive mechanism (not shown). This computer-readable medium may include a non-transitory computer-readable medium such as a floppy drive, a disc, a tape, a Digital Versatile Disc (DVD)/compact disc (CD)-ROM drive, and a memory card. In other example embodiments of the inventive concepts, the software elements may be loaded into the memory 240 through the network interface 230 from a source other than the computer-readable medium.

The bus 220 may facilitate communication and data transmission between elements of the payment system 200. The bus 220 may be configured using a high-speed serial bus, a parallel bus, a storage area network (SAN), and/or other proper communication technologies.

The network interface 230 may be a computer hardware element for connecting the payment system 200 to a computer network. The network interface 230 may be a network interface card, such as an Ethernet card, an optical transceiver, a radio frequency (RF) transceiver, or any device of another type which may transmit and receive information. The network interface 230 may be mobile computing devices and a wireless device which includes Bluetooth, 3 generation (3G), wireless-Fidelity (Wi-Fi) in a universal serial bus (USB). According to example embodiments of the inventive concepts, the network interface 230 may allow the payment system 200 to wirelessly communicate with a server, a mobile phone, or an external device such as another computing device which acts as a network. The network interface 230 may connect the payment system 200 to a computer network through a wireless or wired connection.

The database 250 may store and maintain information associated with a payment on delivery. For example, the database 250 may store goods identification data associated with goods, user identification data of a user who is registered in a mobile application, and ordered records associated with the user identification data. Also, the database 250 may store and maintain information necessary for processing payment of goods. While in FIG. 2 the database 250 is included in the payment system 200, example embodiments of the inventive concepts are not be limited thereto. For example, in some example embodiments, the database 250 may be omitted. Alternatively, in some example embodiments, at least a portion of the database 250 may be an external database constructed on a separate system.

The processor 210 may be configured to process instructions of a computer program by performing basic arithmetic operations, basic logic operations, and input-output operations of the payment system 200. The instructions may be provided to the processor 210 in the form of program codes through the bus 220 by the memory 240 or the network interface 230. The program codes may be stored in a recording device such as the memory 240.

When the processor 210 executes the program codes stored, for example, in the memory 240, the processor 210 may be transformed into a special purpose processor configured to perform the functions of the receiving unit 211, the generating unit 212, the processing unit 213, and the executing unit 214.

The processor 210, when performing the functions of the receiving unit 211, may receive a selection signal, from a user terminal (not shown) in which the mobile application is installed, that a payment method associated with goods is designated as a payment mode for goods. In other example embodiments, rather than receive the selection signal from the user terminal, the receiving unit 211 may select the payment method when the user logs into the mobile application according to user identification data of the user. The mobile application may be a messenger application or a separate application program which may be linked with the messenger application.

The processor 210, when performing the functions of the generating unit 212 may generate an order request signal as a payment server matches goods identification data associated with goods with the user identification data of the user who is registered in the mobile application to correspond to each other. The payment server may connect with the user terminal over a network. As the goods identification data associated with the goods are matched to the mobile application which logged in using the user identification data, the generating unit 212 may output ordered records associated with the goods ordered from the user.

The processor 210, when performing the functions of the generating unit 212, may provide a notification indicating that the process of preparing the goods for delivery has started according to the ordered records associated with the goods and delivery information associated with the goods. The generating unit 212 may push a delivery position for the goods ordered through the logged-in mobile application as the delivery process is started.

As the user terminal executes the mobile application according to an operation of the user who receives the goods, the processing unit 213 may verify ordered records associated with the user identification data and may start a payment session for payment. The processing unit 213 may output an ordered record list including ordered records corresponding to the goods ordered through the mobile application which is logged in to the user terminal. As the user selects at least one ordered record on the output ordered record list, the processing unit 213 may output detailed ordered records. As the user selects ordered records for the goods in which reception is completed as the reception of the goods is completed, the processing unit 213 may provide an interface for processing that a delivery and payment corresponding to the selected ordered records is completed.

The processing unit 213 may generate a quick response (QR) code or a bar code for payment when the user receives the goods. The processing unit 213 may recognize the QR code or bar code from the mobile application which is logged in to the user terminal and may start the payment session for payment. The processing unit 213 may perform payment by processing payment transaction corresponding to the ordered records.

The processing unit 213 may start the payment session for payment as the user selects ordered records and may perform payment by processing a payment transaction corresponding to the selected ordered records. The processing unit 213 may output a message, which is associated with processing the payment transaction according to the payment corresponding to the ordered records is performed, through the logged-in mobile application.

The processor 210, when performing the functions of the executing unit 214, may receive a payment completion signal generated from the payment session and may pay for the goods according to goods identification data.

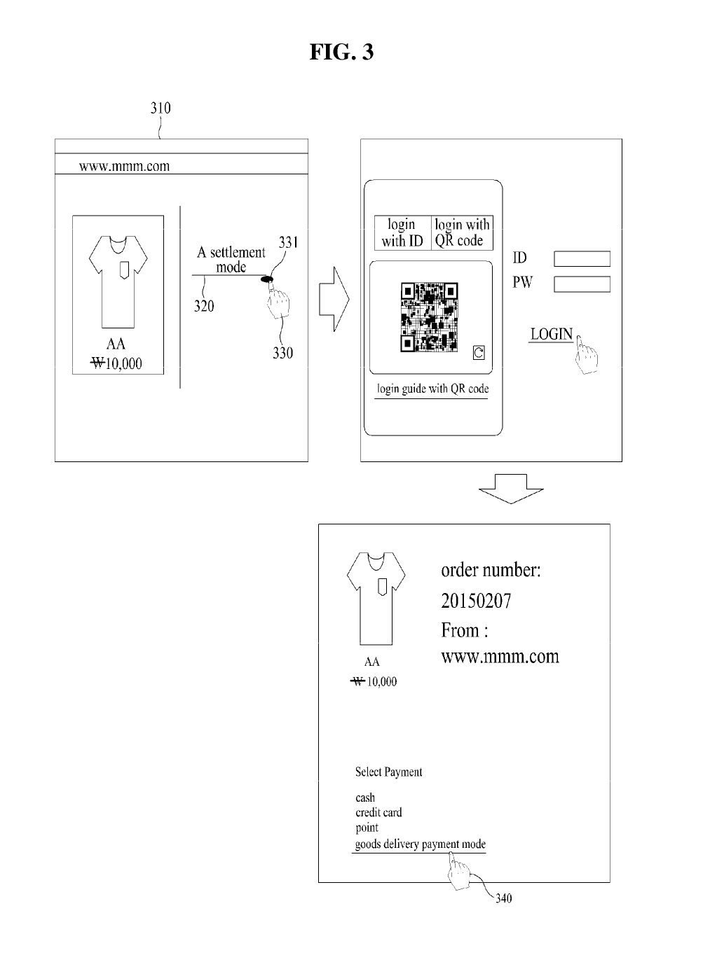

FIG. 3 is a drawing illustrating a process of ordering goods in a payment system according to an example embodiment of the inventive concepts.

Referring to FIG. 3, a user 330 may access a selling site 310 which sells goods, and orders goods. For example, the selling site 310 may be a website, and the goods may be ‘AA’. The user 330 may select the ‘AA goods’ to purchase the ‘AA goods’ on the selling site 310. The selling site 310 may provide a page for the selected ‘AA goods’ that provides information about the ‘AA goods’. For example, the ‘AA goods’ page may provide detailed information including a name, a price, sizes, colors, and order quantities that are available of the ‘AA goods’.

The selling site 310 may provide a settlement mode interface to allow the user 330 to select at least one settlement mode as a settlement mode for goods. In this case, the settlement mode interface may include, for example, a settlement mode for performing payment through a mobile application, a settlement mode for performing payment through the selling site 310, and the like. The user 330 may select the settlement mode linked with the mobile application by selecting 331 a type ‘A settlement mode 320’ among the settlement modes for goods.

The payment system 100 may provide an interface for allowing a user to enter their user identification data in a mobile application. In this case, the payment system 100 may provide the interface, for allowing the user to enter the user identification data of a user who is registered in the mobile application, through the mobile application or the selling site 310. For example, as the user 330 selects a payment mode linked with a mobile application with respect to the “AA goods” on the selling site 310, the payment system 100 may provide the interface requesting the user enter the user identification data registered in the mobile application. The user 330 may log in to the mobile application by entering an identification (ID) and a password, which are registered in the mobile application, through the interface output from the selling site 310. Also, the payment system 100 may provide a quick response (QR) code to the selling site 310 such that the user 330 may log in to the mobile application through the QR code.

The payment system 100 may generate an order request signal by matching goods identification data associated with goods with the user identification data of the user to correspond to each other. In some example embodiments, the goods identification data may include a merchant ID for purchasing goods and an order ID including purchased records of goods and a payment on delivery. The user identification data may include a user ID for registering a mobile application and may be utilized to match information about the goods identification data to the registered mobile application.

As the user 330 logs in to the mobile application, ordered records for goods selected by the user 330 may be output. A user terminal may output a payment mode interface to perform payment among ordered records for the ordered ‘AA goods’, for example, a price, an order number, an ordered selling site, and a settlement mode linked with a mobile application. In this case, payment modes for ordered goods may include a mode for paying in cash or by credit card or utilizing prepaid points, a payment on delivery for deferred payment, and the like. The user 330 may request an order by selecting the payment on delivery as a payment mode for goods.

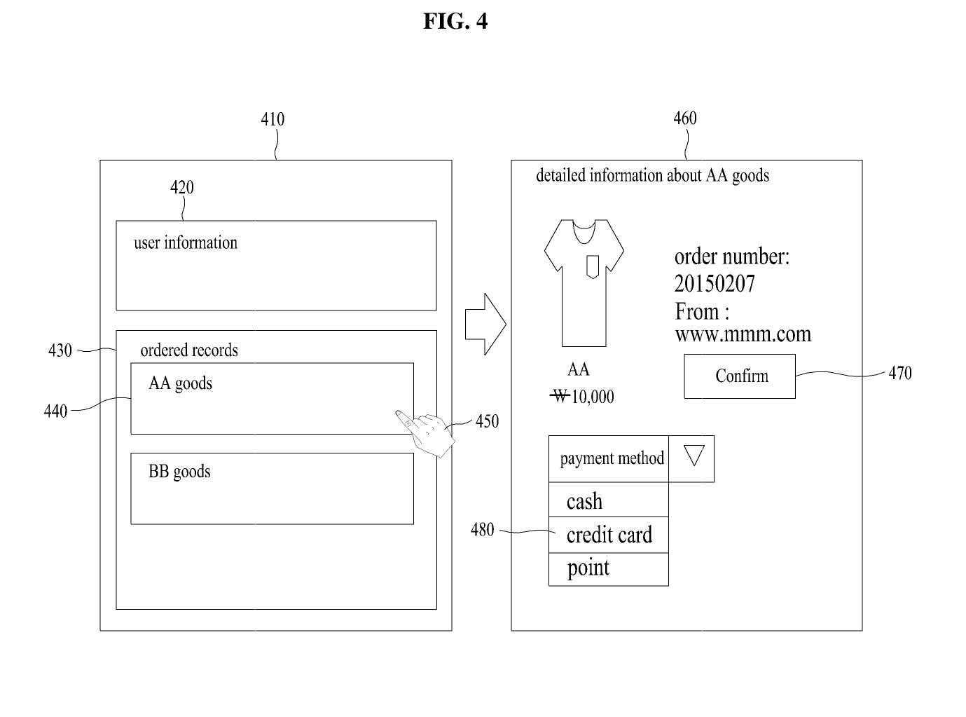

FIGS. 4 to 6 are drawings illustrating a process of performing a payment on delivery in a payment system according to an example embodiment of the inventive concepts.

The payment system 100 may output ordered records associated with goods ordered by a user as goods identification data associated with the goods are matched to a mobile application which is logged in using user identification data.

Referring to FIG. 4, the mobile application 410 may transmit user information stored in a user information region 420 to the payment system 100. The user information may include a user ID, user card information, and the like, which is registered by the user on a user information region 420. The payment system may provide the mobile application 410 with ordered records 430 for goods ordered by the user.

The payment system 100 may output an ordered record list, including ordered records corresponding to ordered goods, through the logged-in mobile application 410. As a user 450 selects at least one ordered record on the output ordered record list, the payment system 100 may output detailed ordered records.

For example, when the user 450 selects ‘AA goods 440’ among ordered records output on the mobile application 410, the mobile application 410 may output detailed information 460 about the ‘AA goods 440’. The detailed information 460 for the ‘AA goods 440’ may include a name, a price, and an order number for the ‘AA goods 440’, a confirm button 470 for processing that a delivery is completed, and a payment interface for selecting a payment on delivery.

As a user terminal may execute the mobile application 410 according to an operation of the user 450 who receives goods, the payment system 100 may verify ordered records associated with user identification data and may start a payment session for payment. The payment system 100 may receive a payment completion signal generated from the payment session and may pay for goods according to goods identification data.

For example, the user 450 may review the detailed information 460 associated with the ‘AA goods’, may verify the ‘detailed information’ about the selected AA goods, and may click the confirm button 470 to confirm that the associated goods, for example, the “AA goods” have been delivered and conform to the detailed information. The payment system 100 may provide a payment interface for the user 450 to pay in cash, by credit card, point, or other payment methods. If the user wishes to pay by credit card, the user 450 may pay by credit card by selecting the pay by credit card button 480.

Also, for example, a delivery service provider may deliver goods to the user 450 and may generate a QR code or a bar code from an application which interworks with the delivery service provider to process payment. As the user 450 recognizes the QR code or the bar code generated from the application which interworks with the delivery service provider through a mobile application which is logged in to the user terminal 450, the payment system 100 may start a payment session for payment and may perform payment by processing a payment transaction corresponding to ordered records. In this case, the application which interworks with the delivery service provider and the mobile application may interwork with each other through an application program interface (API). Also, the mobile application may be a messenger application or may be a separate application program which may be linked with the messenger application.

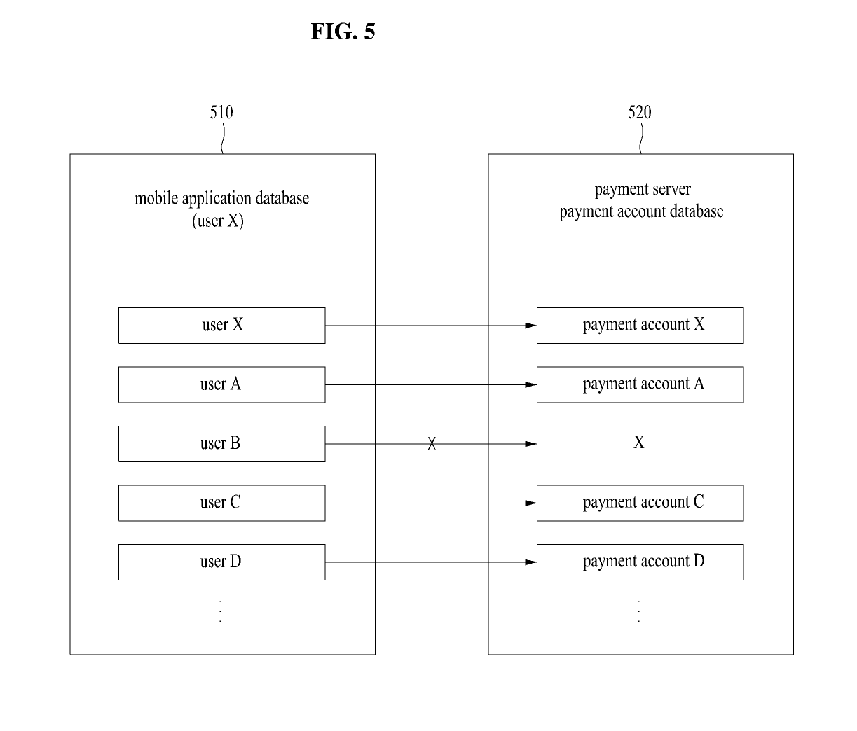

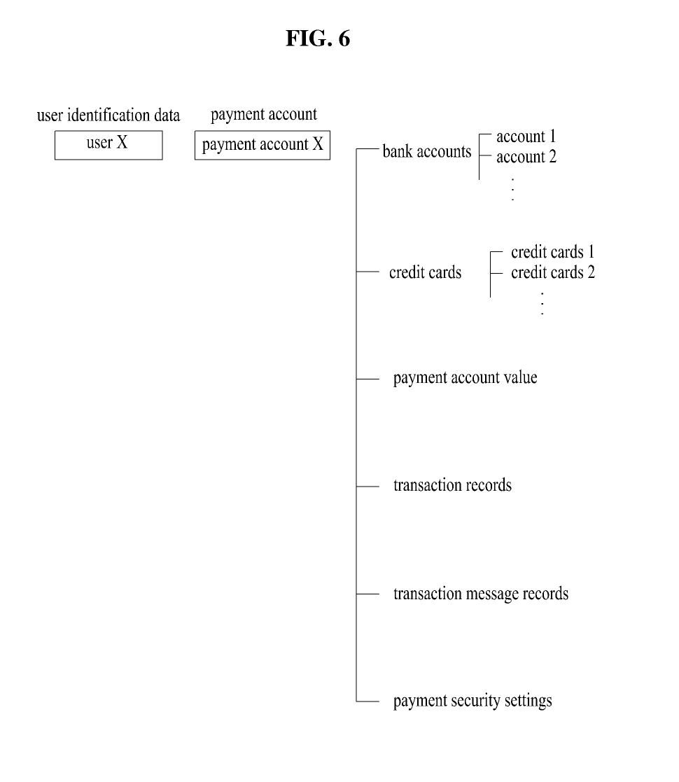

FIGS. 5 and 6 are drawings illustrating a payment transaction of a payment system according to an example embodiment of the inventive concepts.

Referring to FIG. 5, the payment system 100 may store user identification data for each user in a mobile application database 510. Also the payment system 100 may store payment accounts which allow users who are registered in a mobile application to perform payment, and may map the user identification data stored in the mobile application database 510 with information of the payment accounts stored in the payment account database 520 such that users and the payment accounts are matched one-to-one.

The mobile application database 510 may store user identification data about users, for example, a user X, a user A, a user B, a user C, a user D, and the like who are registered in the mobile application. The payment account database 520 may store payment accounts with respect to users who generate payment accounts to perform payment among the users who are registered in the mobile application. For example, the user X may generate a payment account X to perform payment. The payment account database 520 may map the payment account X with the user X. Therefore, the user X may perform payment for goods using the mobile application.

Referring to FIG. 6, the payment system stores (or, alternatively, pre-stores) payment types to perform payment with respect to the user X and the payment account X corresponding to the user X.

For example, as the user X receives goods, the user X may previously generate payment accounts to perform payment for the goods and may register cash charging, bank accounts, or credit cards, and the like through the generated payment accounts. In this case, the user X may register bank accounts or credit cards, and the like through the mobile application. The payment system may further store transaction records, transaction message records, and the like with respect to users and payment accounts corresponding respectively to the users.

As shown in FIGS. 5 and 6, the payment system 100 according to an example embodiment of the inventive concepts may register users and payment accounts corresponding respectively to the users. As the user receives goods from a delivery service provider, a user terminal may execute a mobile application, may verify ordered records output through the mobile application, and may pay for the goods through a previously registered payment function. When the payment is processed, the payment system 100 may provide a message indicating that the payment has been processed to the mobile application. As the payment for the goods is processed, the payment system 100 may settle a price of the goods through an external financial institution.

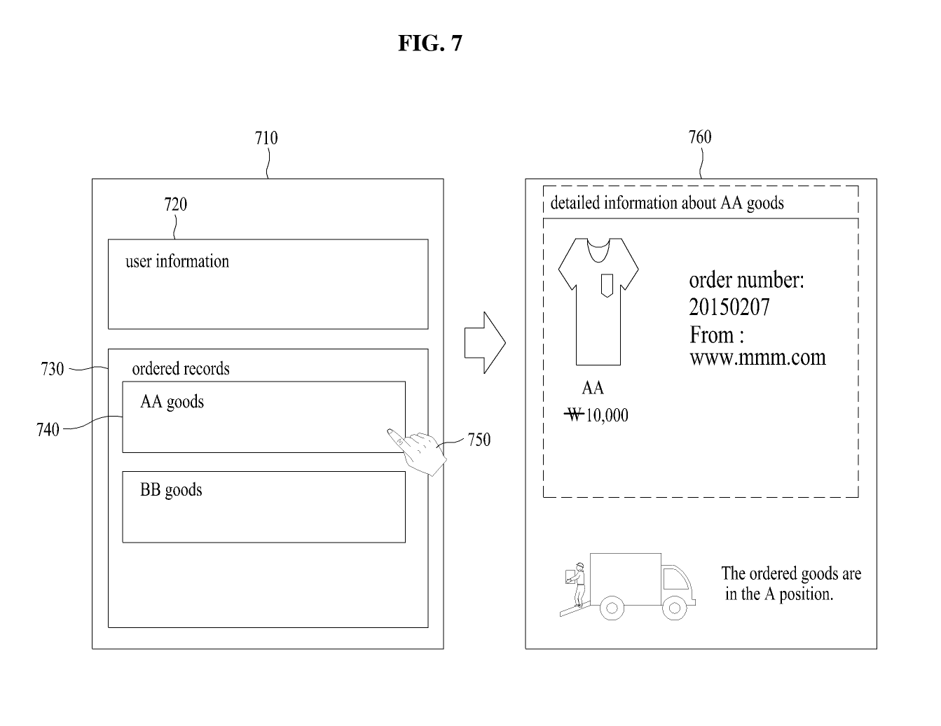

FIG. 7 is a drawing illustrating a process of outputting ordered records for goods in a payment system according to an example embodiment of the inventive concepts.

Referring to FIG. 7, the payment system 100 may output ordered records for goods. As described above with reference to FIG. 4, the payment system 100 may output the ordered records for the goods through a logged-in mobile application 710. The payment system 100 may output an ordered record list 730, including ordered records corresponding to ordered goods, to the logged-in mobile application 710. As a user 750 selects at least one ordered record on the output ordered record list, the payment system 100 may output detailed ordered records.

For example, when the user 750 selects ‘AA goods 740’ on the output ordered records, the mobile application may output detailed information 760 about the ‘AA goods 740’. In some example embodiments the payment system 100 may provide the detailed information 760 to the mobile application.

The detailed information 760 about the ‘AA goods 740’ may include a name, a price, an order number, presence or not of a delivery, a delivery position, and the like with respect to the ‘AA goods 740’. For example, the delivery position for the ‘AA goods 740’ may be output on a region of the detailed information 760 about the ‘AA goods 740’.

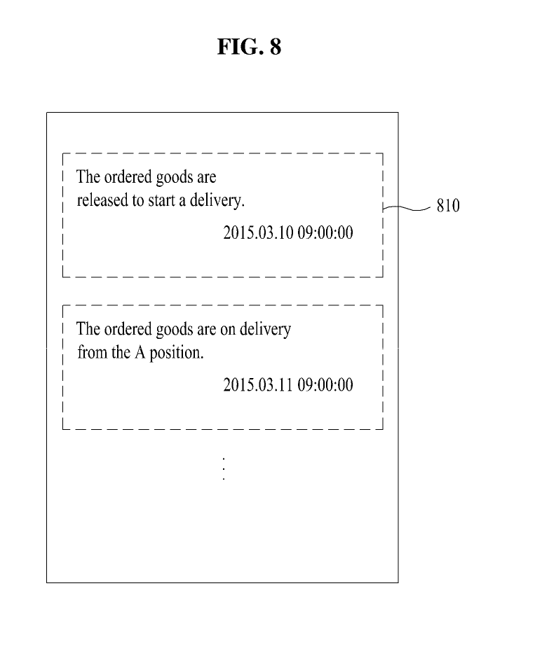

FIG. 8 is a drawing illustrating a process of notifying a delivery position for goods in a payment system as a delivery is started according to an example embodiment of the inventive concepts.

Referring to FIG. 8, the payment system 100 may provide a notification through a mobile application, that the process of preparing goods for delivery has started, according to ordered records associated with goods and delivery information associated with the goods. The payment system 100 may transmit a message 810 indicating a current location of the goods and may output the current location on the mobile application. In some example embodiments, the payment system 100 may transmit the message indicating the location of the goods 810 periodically. For example, the payment system 100 may inform the user of the location of ‘AA goods’ ordered through the mobile application in three hour intervals. The user may receive the message 810 through the logged-in mobile application. For example, the mobile application may output a message, ‘the ordered goods are in route and are last recorded as being at the A1 position.’

Also, as payment for goods is performed through the mobile application, the payment system 100 may provide a message indicating that a status of processing the payment. The user may receive the message indicating the payment status through the mobile application. For example, as payment for the ‘AA goods’ is performed, the mobile application may output a message, ‘the payment for the AA goods is completed.’

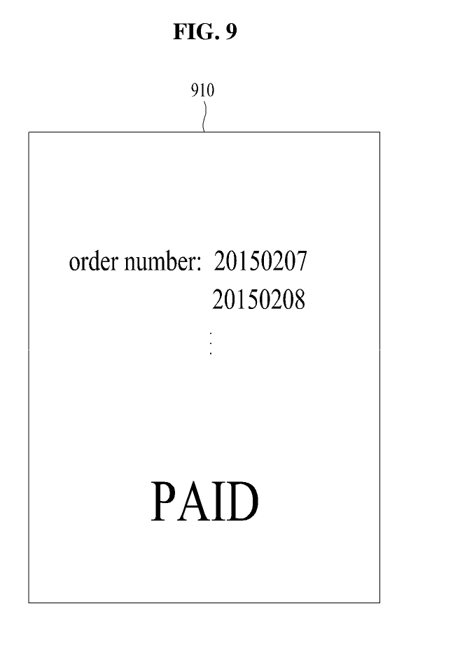

FIG. 9 is a drawing illustrating a process of providing notification that a delivery is completed to a delivery service provider in a payment system as a delivery is completed according to an example embodiment of the inventive concepts.

Referring to FIG. 9, as a delivery is completed, the payment system 100 may release funds to a merchant or/and a delivery service provider and may provide notification that the delivery is completed. For example, a terminal of a delivery service provider, such as a delivery service company, may output an order number for goods in which payment is completed as a user receives the goods, and may display information indicating that the payment is completed. Specifically, assuming that an order number of ‘AA goods’ is 2015207, when the user pays for the received ‘AA goods’, the payment system 100 may provide notification that the payment is completed to the delivery service provider. Also, the terminal of the delivery service provider may output the order number in which the payment is completed.

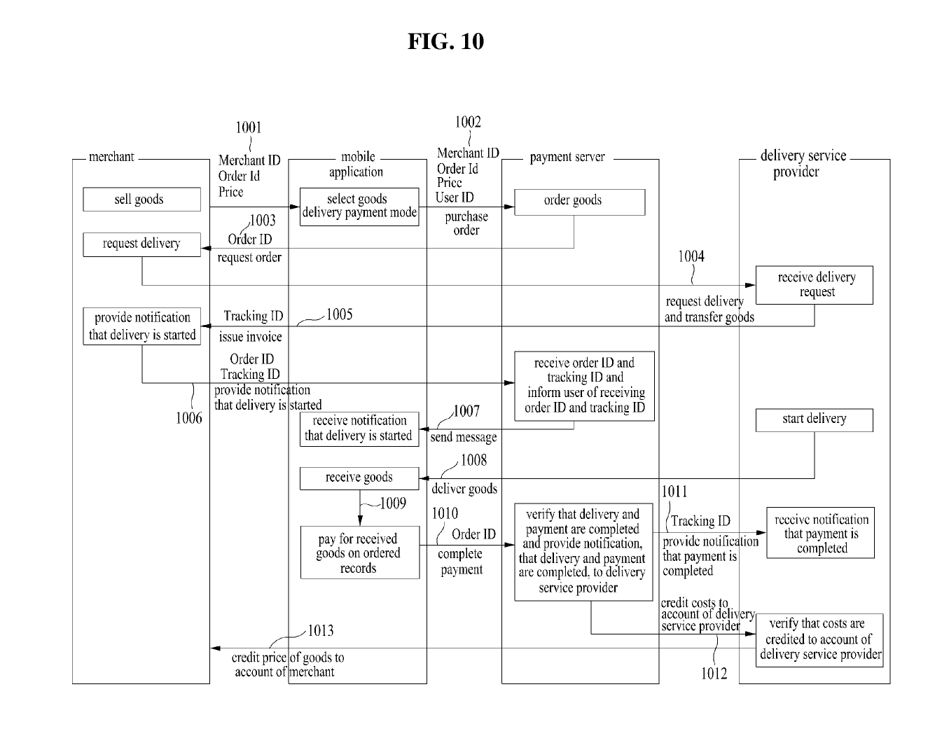

FIG. 10 is a signal sequence diagram illustrating an operation of a payment method in a payment system according to an example embodiment of the inventive concepts.

Referring to FIG. 10, the payment system 100 may notify a user of a current delivery condition of goods based on data from one or more of a merchant, a mobile application, a payment server, and a delivery service provider, and the payment system 100 may process payment for goods. The payment system 100 may provide an interface for the user to pay for the goods in a payment on delivery.

In operation 1001, when a user requests goods from a merchant through as selling site operated by the merchant and selects a payment on delivery as a form of payment, the merchant may transmit information including an ID of the selling site and goods ordered records, for example, a merchant ID, an order ID, a price, and the like to the mobile application.

In operation 1002, the mobile application may order the goods by transmitting, to the payment server associated with the payment system 100, the received merchant ID, order ID, and price and user identification data (e.g. a user registered in the mobile application).

In operation 1003, the payment server may request the ordered goods by transmitting the order ID to the merchant.

In operation 1004, the merchant may request that the delivery service provider deliver the goods according to the order ID transmitted to the user and the order ID received from the payment server. Further, the merchant may transfer possession of the goods to the delivery service provider. The delivery service provider may receive the delivery request and the goods from the merchant.

In operation 1005, the delivery service provider may issue an invoice and a tracking ID to the merchant.

In operation 1006, the merchant may transmit the order ID and the tracking ID associated with the goods to the payment server to provide notification, that the goods are being prepared for delivery, to the user.

In operation 1007, the payment server may transmit a message to the mobile application to inform the user that the delivery process has commenced. The user may receive the notification, that the delivery has started, through the mobile application.

In operation 1008, the delivery service provider may deliver the goods to the user.

In operation 1009, the user may indicate, via the mobile application, that the goods have been received and conform to the users expectations.

In operation 1010, the user may pay for the received goods through the mobile application, and the mobile application may transmit a message indicating that the payment is completed by transmitting the order ID to the payment server. The payment server may verify that the delivery and payment is completed.

In operation 1011, as the payment is completed, the payment server may provide a notification to the delivery service provider indicating that the user has received and paid for the goods. For example, the payment server may transmit the tracking ID to the delivery service provider. The delivery service provider may receive the notification, that the delivery is completed, from the payment server.

In operation 1012, the payment server may credit costs to an account of the delivery service provider according to a contract relationship between the payment system, the delivery service provider, and the merchant.

In operation 1013, the delivery service provider may credit a price of the goods to an account of the merchant as verifying that the costs are credited from the payment server. The payment server may also credit the cost of the delivery to an account of the delivery service provider.

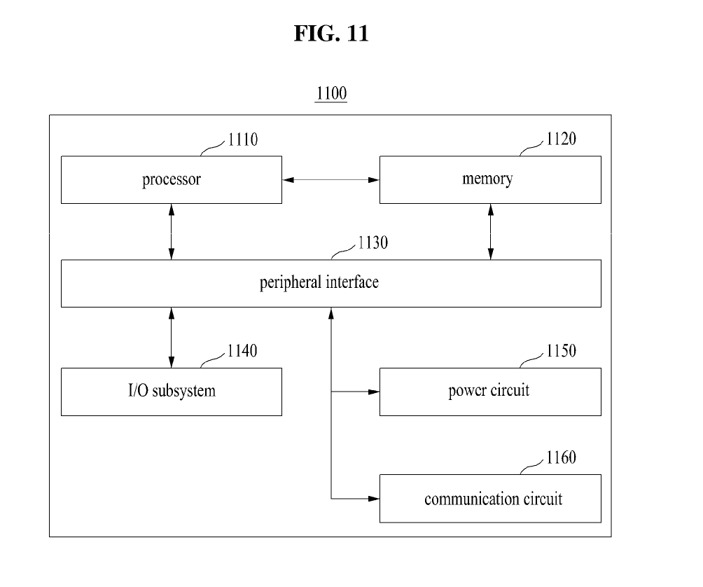

FIG. 11 is a block diagram illustrating a configuration of a computer system according to an example embodiment of the inventive concepts.

As shown in FIG. 11, a computer system 1100 may include at least one processor 1110, a memory 1120, a peripheral interface 1130, an input/output (I/O) subsystem 1140, a power circuit 1150, and a communication circuit 1160. In this case, the computer system 1100 may correspond to a user terminal.

The memory 1120 may include, for example, a high-speed random access memory (RAM), a magnetic disc, a static RAM (SRAM), a dynamic RAM (DRAM), a read only memory (ROM), a flash memory, or a nonvolatile memory. The memory 1120 may include software modules, instruction sets, or various other data, which are necessary for an operation of the computer system 1100. In this case, to access the memory 1120 at the processor 1110 or another component such as the peripheral interface 1130 may be controlled by the processor 1110.

The peripheral interface 1130 may combine an input and/or output peripheral of the computer system 1100 to the processor 1110 and the memory 1120. The processor 1110 may execute a software module or an instruction set which is stored in the memory 1120, may perform various functions for the computer system 1100, and may process data.

The I/O subsystem 1140 may combine various I/O peripherals to the peripheral interface 1130. For example, the I/O subsystem 1140 may include a controller for combining a peripheral, such as a monitor, a keyboard, a mouse, or a printer or a touch or a sensor if necessary to the peripheral interface 1130. According to another example embodiment of the inventive concepts, I/O peripherals may be combined to the peripheral interface 1130 without the I/O subsystem 1140.

The power circuit 1150 may supply power to all or some of components of the computer system 1100. For example, the power circuit 1150 may include a power management system, one or more power supplies such as a battery or an alternating current (AC) power supply, a charting system, a power failure detection circuit, a power converter or inverter, a power state indicator, or other components for power generation, management, and distribution.

The communication circuit 1160 may facilitate communication with another computer system using at least one external port. Alternatively, as described above, if necessary, the communication circuit 1160 may include a radio frequency (RF) circuit, and may facilitate communication with another computer system by transmitting and receiving an RF signal known as an electromagnetic signal.

The communication circuit 1160 may include a circuit for RF communication of various communication schemes (wireless-fidelity (Wi-Fi), 3 generation (3G), long term evolution (LTE), Bluetooth, near field communication (NFC), Zigbee, and the like). Components which may be included in the computer system 1400 may be implemented with hardware, which includes an integrated circuit (IC) specialized for one or more signaling or applications, software, or combinations thereof.

In some example embodiments, the computer system 1100 may include components not illustrated in FIG. 11. For example, the computer system 100 may further include a touch screen or a sensor, and the like, in addition to the components shown in FIG. 11.

Methods according to example embodiments of the inventive concepts may be implemented with program instructions which may be performed through various computer systems and may be recorded in a non-transitory computer-readable medium. Particularly, example embodiment of the inventive concepts may be implemented via a personal computer (PC)-based program or a mobile terminal dedicated application, that when executed by a processor, transform the processor into a special purpose processor. A messenger application to which an example embodiment of the inventive concepts may be implemented with a program which operates independently or may be implemented with an in-app type of a specific application. The messenger application may be implemented to operate on the specific application. Also, this application may be installed in a user terminal through files provided from a file distribution system. For example, the file distribution system may include a file transmitting unit (not shown) which transmits the files according to a request of the user terminal.

As such, the payment system 100 according to an example embodiment of the inventive concepts may more improve satisfaction of goods ordered from users through the payment on delivery. Also, the payment system 100 may reduce a burden on the delivery service provider by performing payment through the mobile application. The payment system 100 may have a variety of mobile payment in addition to payment in cash.

The payment system 100 according to an example embodiment of the inventive concepts may more improve satisfaction of goods ordered from users by providing the payment on delivery. The payment system 100 may have various payment modes in addition to the cash mode by performing payment through the mobile application.

The payment system according to an example embodiment of the inventive concepts may allow users who use the mobile application to conveniently perform payment through a payment transaction by providing the payment platform which may be combined with the mobile application.

The payment system according to an example embodiment of the inventive concepts may allow users to verify a process from a delivery to payment by outputting a message indicating delivery information about goods ordered through the mobile application and a procedure of a payment transaction.

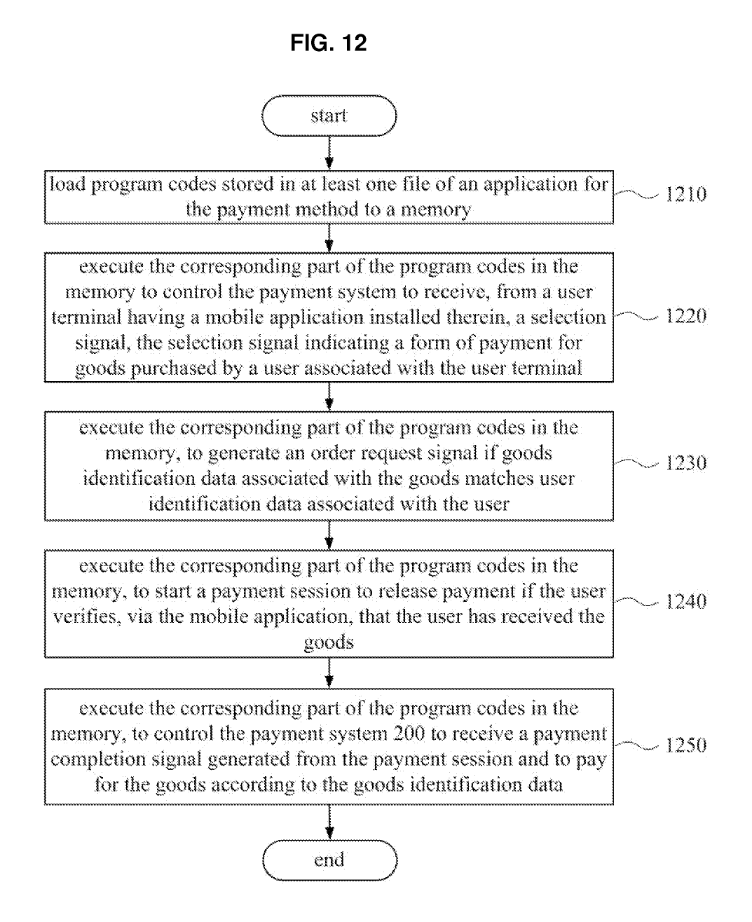

FIG. 12 is flow chart illustrating an operation of a payment method according to an example embodiment of the inventive concepts.

Referring to FIG. 12, the processor 210 of FIG. 2, configured as the receiving unit 211, the generating unit 212, the processing unit 213, and the executing unit 214, may perform operations 1210 to 1050 of FIG. 12.

In operation 1210, the processor 210 may load program codes stored in at least one file of an application for the payment method to a memory (e.g., the memory 240), when the application is executed in the payment system 200.

In operation 1220, the receiving unit 211 may execute the corresponding part of the program codes in the memory, to control the payment system 200 to receive, from a user terminal having a mobile application installed therein, a selection signal, the selection signal indicating a payment on delivery as a form of payment for goods purchased by a user associated with the user terminal. For example, the receiving unit 211 may automatically select the payment on delivery as the form of payment according to the selections signal generated when the user logs in to the mobile application using the user identification data associated with the user.

In operation 1230, the generating unit 212 may execute the corresponding part of the program codes in the memory, to generate an order request signal if goods identification data associated with the goods matches user identification data associated with the user. The generating unit 212 may control the user terminal though the mobile application to output ordered records associated with the goods ordered by the user when the goods identification data is matched to the user identification data. The payment system 200 may provide a notification, the notification indicating that a delivery process of delivering the goods has commenced based on ordered records associated with the goods and delivery information associated with the goods. The payment system 200 may send a location of the ordered goods to the mobile application when the delivery process commences.

In operation 1240, the processing unit 213 may execute the corresponding part of the program codes in the memory, to start a payment session to release payment if the user verifies, via the mobile application, that the user has received the goods. The payment system 200 may output an ordered record list, the ordered record list including a summary of ordered records corresponding to the goods ordered from the user via the mobile application and output details associated with a selected one of the ordered records when the user selects the selected one of the ordered records on the ordered record list. The payment system 200 may provide an interface for processing that a delivery of the goods and payment corresponding to the selected one of the ordered records are complete when the user indicates that the goods corresponding to the selected one of the ordered records is delivered.

The payment system 200 may generate a quick response (QR) code or a bar code, and instruct one or more of a merchant and a delivery service provider to place the QR code or the bar code on the goods. The payment system 200 may receive the QR code or bar code from the mobile application after the goods are delivered and perform the payment by processing a payment transaction corresponding to the ordered records, if the QR code or the bar code is received. The payment system 200 may start the payment session to process payment for the selected one of the ordered record selected by the user and perform the payment by processing a payment transaction corresponding to the selected ordered records using the form of payment indicated in the selection signal. The payment system 200 may output a message associated with processing the payment transaction through the mobile application as the payment corresponding to the selected one of ordered records is performed.

In operation 1250, the executing unit 214 may execute the corresponding part of the program codes in the memory, to control the payment system 200 to receive a payment completion signal generated from the payment session and to pay for the goods according to the goods identification data.

The payment system according to example embodiments of the inventive concepts may provide a location of the ordered goods, processing of a payment transaction, and a payment history by integration. Therefore, a quality of a content for payment service and an efficiency of the network resources may be improved.

The foregoing devices may be realized by hardware elements, software elements and/or combinations thereof. For example, the devices and components illustrated in the example embodiments of the inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Alternatively, the processing unit may have a different processing configuration, such as a parallel processor.

Software may include computer programs, codes, instructions or one or more combinations thereof and configure a processing unit to operate in a desired manner or independently or collectively control the processing unit. Software and/or data may be permanently or temporarily embodied in any type of machine, components, physical equipment, virtual equipment, computer storage media or units or transmitted signal waves to be interpreted by the processing unit or to provide instructions or data to the processing unit. Software may be dispersed throughout computer systems connected via networks and be stored or executed in a dispersion manner. Software and data may be recorded in one or more computer-readable storage media.

The methods according to the above-described example embodiments of the inventive concepts may be implemented with program instructions which may be executed by various computer means and may be recorded in computer-readable media. The computer-readable media may also include, alone or in combination with the program instructions, data files, data structures, and the like. The program instructions recorded in the media may be designed and configured for the example embodiments of the inventive concepts or be known and available to those skilled in computer software. Computer-readable media may include magnetic media such as hard disks, floppy disks, and magnetic tape; optical media such as CD ROM disks and DVDs; magneto-optical media such as optical disks; and hardware devices which are specially configured to store and perform program instructions, such as a read-only memory (ROM), a random access memory (RAM), a flash memory, and the like. Program instructions may include both machine codes, such as produced by a compiler, and higher-level language codes which may be executed by the computer using an interpreter. The described hardware devices may be configured to act as one or more software modules to perform the operations of the above-described example embodiments of the inventive concepts, or vice versa.

While a few example embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. A processing method implemented with a computer, the method comprising:
receiving, from a user terminal having a mobile application installed therein, a selection signal, the selection signal indicating a payment on delivery as a form of payment for goods purchased by a user associated with the user terminal;
generating an order request signal if goods identification data associated with the goods matches user identification data associated with the user;
starting a payment session to release payment if the user verifies, via the mobile application, that the user has received the goods; and
receiving a payment completion signal generated from the payment session and paying for the goods according to the goods identification data.

2. The method of claim 1, wherein the receiving a selection signal comprises:
automatically selecting the payment on delivery as the form of payment when the user logs in to the mobile application using the user identification data associated with the user.

3. The method of claim 1, wherein the mobile application is a messenger application or a separate application program linked with the messenger application.

4. The method of claim 1, wherein the generating an order request signal comprises:
outputting ordered records associated with the goods ordered by the user when the goods identification data is matched to the user identification data.

5. The method of claim 4, wherein
the user identification data comprises a merchant identification (ID) and an order ID, the merchant ID associated with a merchant who sells the goods via a selling site, and the order ID including purchased records of the goods, and
the user identification data includes a user ID associated with logging into the mobile application.

6. The method of claim 1, wherein the generating an order request signal comprises:
providing a notification, the notification indicating that a delivery process of delivering the goods has commenced based on ordered records associated with the goods and delivery information associated with the goods.

7. The method of claim 6, wherein the generating an order request signal further comprises:
sending a location of the ordered goods to the mobile application when the delivery process commences.

8. The method of claim 1, wherein starting a payment session comprises:
outputting an ordered record list, the ordered record list including a summary of ordered records corresponding to the goods ordered from the user via the mobile application; and
outputting details associated with a selected one of the ordered records when the user selects the selected one of the ordered records on the ordered record list.

9. The method of claim 8, wherein starting a payment session further comprises:
providing an interface for processing that a delivery of the goods and payment corresponding to the selected one of the ordered records are complete when the user indicates that the goods corresponding to the selected one of the ordered records is delivered.

10. The method of claim 1, wherein starting a payment session comprises:
generating a quick response (QR) code or a bar code, and instructing one or more of a merchant and a delivery service provider to place the QR code or the bar code on the goods;
receiving the QR code or bar code from the mobile application after the goods are delivered; and
performing the payment by processing a payment transaction corresponding to the ordered records, if the QR code or the bar code is received.

11. The method of claim 9, wherein starting a payment session comprises:
starting the payment session to process payment for the selected one of the ordered record selected by the user; and
performing the payment by processing a payment transaction corresponding to the selected ordered records.

12. The method of claim 11, wherein starting a payment session comprises:
outputting a message associated with processing the payment transaction through the mobile application as the payment corresponding to the selected one of ordered records is performed.

13. A processing system implemented with a computer, the system comprising:
a receiver configured to,
receive, from a user terminal having a mobile application installed therein, a selection signal, the selection signal indicating a payment on delivery as a form of payment for goods purchased by a user associated with the user terminal, and
receive a payment completion signal generated from a payment session; and
a processor configured to,
generate an order request signal if goods identification data associated with the goods matches user identification data associated with the user,
start the payment session to release payment if the user verifies, via the mobile application, that the user has received the goods, and
pay for the goods according to the goods identification data.

14. The system of claim 13, wherein the processor is configured to automatically select the payment on delivery as the form of payment when the user logs in to the mobile application using the user identification data associated with the user.

15. The system of claim 13, wherein the mobile application is a messenger application or a separate application program linked with the messenger application.

16. The system of claim 13, wherein the processor is configured to output ordered records associated with the goods ordered by the user when the goods identification data matches the user identification data.

17. The system of claim 16, wherein the user identification data comprises:
a merchant ID and an order ID, the merchant ID associated with a merchant who sells the goods via a selling site, and the order ID including purchased records of the goods, and wherein
the user identification data includes a user ID associated with logging into the mobile application.

18. The system of claim 13, wherein the processor is configured to transmit a notification, the notification indicating that a delivery processor of delivering the goods has commenced based on ordered records associated with the goods and delivery information associated with the goods.

19. The system of claim 18, wherein the processor is configured to transmit a location of the ordered goods to the mobile application when the delivery processor commences.

20. The system of claim 13, wherein the processor is configured to,
output an ordered record list, the ordered record list including a summary of ordered records corresponding to the goods ordered from the user via the mobile application, and
output details associated with a selected one of the ordered records when the user selects the selected one of the ordered records on the ordered record list.

21. The system of claim 20, wherein the processor is configured to provide an interface for processing that a delivery of the goods and the payment corresponding to the selected one of the ordered records are complete when the user indicates that the goods corresponding to the selected one of the ordered records is delivered.

22. The system of claim 13, wherein the processor is configured to,
generate a quick response (QR) code or a bar code, and instructing one or more of a merchant and a delivery service provider to place the QR code or the bar code on the goods,
receive the QR code or bar code from the mobile application after the goods are delivered, and
perform the payment by processing a payment transaction corresponding to the ordered records, if the QR code or the bar code is received.

23. The system of claim 21, wherein the processor is configured to,
start the payment session to processor the payment for the selected one of the ordered records selected by the user, and
perform the payment by processing a payment transaction corresponding to the selected ordered records.

24. The system of claim 23, wherein the processor is configured to output a message associated with processing the payment transaction through the mobile application as the payment corresponding to the selected one of ordered records is performed.

25. A processing method implemented with a computer, the method comprising:
selecting a payment on delivery as a form of payment for goods to be purchased by a user requesting an order for the goods by transmitting, to a payment server, goods identification data associated with the goods and user identification data of the user;
providing, when the receipt of the goods to the user is verified, a payment interface to the user, the payment interface allowing the user to authorize payment for the goods; and
outputting a message associated with processing a payment transaction corresponding to an ordered record associated with the user identification data in response to the payment for the goods through the payment interface.

26. The method of claim 25, wherein the requesting comprises:
outputting the ordered record if the goods identification data matches the user identification data.

27. The method of claim 26, wherein the requesting comprises:
receiving a notification based on the ordered record and delivery information associated with the goods, the notification indicating that a delivery process of the goods has commenced; and
receiving a current location of the goods every set time period after the delivery process has commenced.

28. The method of claim 27, wherein the requesting comprises:
outputting an ordered record list, the ordered record list including a summary of the ordered record; and
outputting details associated with the ordered record when the ordered record on the output ordered record list is selected.
